(19) United States
(12) Patent Application Publication
(10) Pub. No.: US 2026/0289938 A1
(43) Pub. Date: Sep. 24, 2026

(54) SYSTEM AND METHOD FOR AUTOMATED SYMBOL READER INSTALLATION AND TUNING

(71) Applicant: Cognex Corporation, Natick, MA (US)

(72) Inventors: Georges Gauthier, Brookline, MA (US); Amelia Coffey, Sydney (AU); Shirin Saleem, Lexington, MA (US)

(21) Appl. No.: 19/443,172

(22) Filed: Jan. 8, 2026

Related U.S. Application Data
(60) Provisional application No. 63/832,911, filed on Jun. 30, 2025.
(60) Provisional application No. 63/775,870, filed on Mar. 21, 2025.

(51) Int. Cl. G06V 10/24; G06V 10/141; G06V 10/82; H04N 23/63

(52) U.S. Cl. CPC G06V 10/245; G06V 10/141; G06V 10/82; H04N 23/633

(57) ABSTRACT

Systems and associated methods implement or perform receiving, in real-time, an image acquired by an imaging device, determining a symbol size for a symbol in a field-of-view of the imaging device, determining a symbol type for the symbol, comparing the symbol size to a predetermined size range, the predetermined size range being based on the determined symbol type, and providing a feedback based on the comparing, wherein the feedback indicates a relationship between an actual distance between the imaging device and the symbol and a target distance range between the imaging device and the symbol.

### CROSS-REFERENCE TO RELATED APPLICATIONS

This application claims the benefit of and priority to U.S. Application No. 63/832,911, filed June 30, 2025, and U.S. Application No. 63/775,870, filed March 21, 2025, the entire contents of which are herein incorporated by reference for all purposes.

### STATEMENT REGARDING FEDERALLY FUNDED RESEARCH

Not applicable.

### BACKGROUND

Machine vision systems, also termed “vision systems” herein, are used to perform a variety of tasks (such as measurement, inspection, alignment of objects, decoding of symbology, and the like) in a wide range of applications and industries, including a manufacturing environment. In general, a vision system consists of one or more cameras with an image sensor (or “imager”) that acquires grayscale or color images of a scene that contains an object or surface of interest. Images of the object/surface can be analyzed to provide data/information to users and associated manufacturing processes. The data produced by the image is typically analyzed and processed by the vision system in one or more vision system processors that can be purpose-built, or part of one or more software application(s) using either conventional or deep learning/AI-based processes, instantiated within a general purpose computer (e.g. a PC, laptop, tablet or smartphone), or a custom processor.

### SUMMARY

In an aspect, the present disclosure provides a vision system for imaging an object. The vision system comprises an imaging device configured to acquire an image; a memory in communication with the imaging device; and at least one processor operatively connected to the memory and configured to: receive, in real-time, the image acquired by the imaging device, determine a symbol size for a symbol in a field-of-view of the imaging device, determine a symbol type for the symbol, compare the symbol size to a predetermined size range, the predetermined size range being based on the determined symbol type, and provide a real-time feedback based on the comparing, wherein the real-time feedback indicates a relationship between an actual distance between the imaging device and the symbol and a target distance range between the imaging device and the symbol.

In an aspect, the present disclosure provides a method of imaging an object. The method comprises receiving an image in real-time from an imaging device; detecting a symbol in the image; determining a symbol size and a symbol type for the symbol; comparing the symbol size to a predetermined size range, the predetermined size range being based on the determined symbol type; and providing a real-time feedback based on the comparing, wherein the feedback indicates a relationship between an actual distance between the imaging device and the symbol and a target distance between the imaging device and the symbol.

Other features, objects, and advantages of the present invention are apparent in the detailed description that follows. It should be understood, however, that the detailed description, while indicating embodiments of the present invention, is given by way of illustration only, not limitation. Various changes and modifications within the scope of the invention will become apparent to those skilled in the art from the detailed description.

### BRIEF DESCRIPTIONS OF THE DRAWINGS

FIG. 1 illustrates an example vision system according to various aspects of the present disclosure.

FIG. 2 illustrates an example vision system use case according to various aspects of the present disclosure.

FIG. 3 illustrates an example graph of decode performance according to various aspects of the present disclosure.

FIG. 4 illustrates an example graph of tuning parameters according to various aspects of the present disclosure.

FIG. 5 illustrates an example user interface according to various aspects of the present disclosure.

FIG. 6 illustrates an example installation and tuning method according to various aspects of the present disclosure.

### DETAILED DESCRIPTION

Some types of tasks performed by the vision system can include inspection of objects and surfaces (e.g. web inspection) for defects or expected features. Objects and surfaces may be inspected while on a conveyor arrangement, motion stage, or manipulated by a robotic arm. One particular application is symbol reading, in which the vision system inspects objects and surfaces to detect and read encoded information. In comparative examples, symbol readers or other machine vision systems include two setup steps. The first step includes installation (also referred to herein as mounting). The comparative installation process may include acquiring images (e.g., continuously) and attempting to decode symbols within the images, with the images sometimes being shown to the user via a user interface (UI). This mode may be used when mounting the device. The second step includes tuning. In this step, the comparative vision system attempts to improve image formation and symbol reading algorithms to increase the read rate and provide faster decoding. This step is performed once the device has been mounted (e.g., after installation).

However, the comparative techniques for installation and tuning require the user to visually gauge if the symbols are at a favorable size in the images when mounting their devices. In such cases, users tend to gauge printed symbol size by “eye” (rather than in terms of an objective metric such as Pixels Per Module or PPM), mounting the device in a manner such that symbols are clearly visible and in a size range that “feels” correct when viewed via the UI. The mounting position is often selected with user intuition about whether the position will result in the symbol being successfully decoded. Inexperienced users will mount in an even less predictable manner, such that the symbols in the captured images are far below or above the target size for decoding. This leads to poor results at the tuning step, which may necessitate multiple repetitions of the installation step (an in some instances, complete reinstallation), adjusting the position between each tuning attempt. On challenging parts (e.g., parts with high reflectivity or complex surface features, etc.), the comparative techniques may be especially deficient.

The present disclosure addresses these and other shortcomings in the comparative techniques, and sets forth systems and methods that can leverage the use of known (either predetermined or dynamically determined) symbol size or viewing angle constraints in image space (e.g., target PPM ranges) to provide position guidance during the installation step.

Before the present invention is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a,” “an,” and “the” include plural embodiments unless the context clearly dictates otherwise.

It should be apparent to those skilled in the art that many additional modifications beside those explicitly described are possible without departing from the inventive concepts. In interpreting this disclosure, all terms should be interpreted in the broadest possible manner consistent with the context. Variations of the term “comprising,” “including,” or “having” should be interpreted as referring to elements, components, or steps in a non-exclusive manner, so the referenced elements, components, or steps may be combined with other elements, components, or steps that are not expressly referenced. Embodiments referenced as “comprising,” “including,” or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Any citations to publications, patents, or patent applications herein are incorporated by reference in their entirety. Any numerals used in this application with or without about/approximately are meant to cover any normal fluctuations appreciated by one of ordinary skill in the relevant art.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

As used herein, the terms “component,” “system,” “device” and the like are intended to refer to either hardware, firmware, software, software in execution, or any combination thereof. The word "exemplary" is used herein to mean serving as an example, instance, or illustration. Any aspect or design described herein as “exemplary” is not necessarily to be construed as preferred or advantageous over other aspects or designs.

As used herein, “real-time” refers to capture and provision (e.g., display) of image data with minimal processing delay, such that “real-time” images represent the scene as it exists at the current moment, or within a timeframe short enough to be perceived as instantaneous or near-instantaneous by a user. In some examples, “real-time” display of images can include delay of up to 50 milliseconds (ms) between capture and display. In some examples, “real-time” display of images can include delay of up to 100ms, 200ms, or 500ms between capture and display. In some examples, e.g., in a manual focus imaging device, “real-time” display of images can include delay of up to 10,000ms between capture and display.

Furthermore, the disclosed subject matter may be implemented as a system, method, apparatus, or article of manufacture using standard programming or engineering techniques or programming to produce hardware, firmware, software, or any combination thereof to control an electronic based device to implement aspects detailed herein.

Unless specified or limited otherwise, the terms “connected,” “coupled” and variations thereof are used broadly and encompass both direct and indirect mountings, connections, supports, and couplings. Further, “connected” and “coupled” are not restricted to physical or mechanical connections or couplings. As used herein, unless expressly stated otherwise, “connected” means that one element/feature is directly or indirectly connected to another element/feature, and not necessarily electrically or mechanically. Likewise, unless expressly stated otherwise, “coupled” means that one element/feature is directly or indirectly coupled to another element/feature, and not necessarily electrically or mechanically.

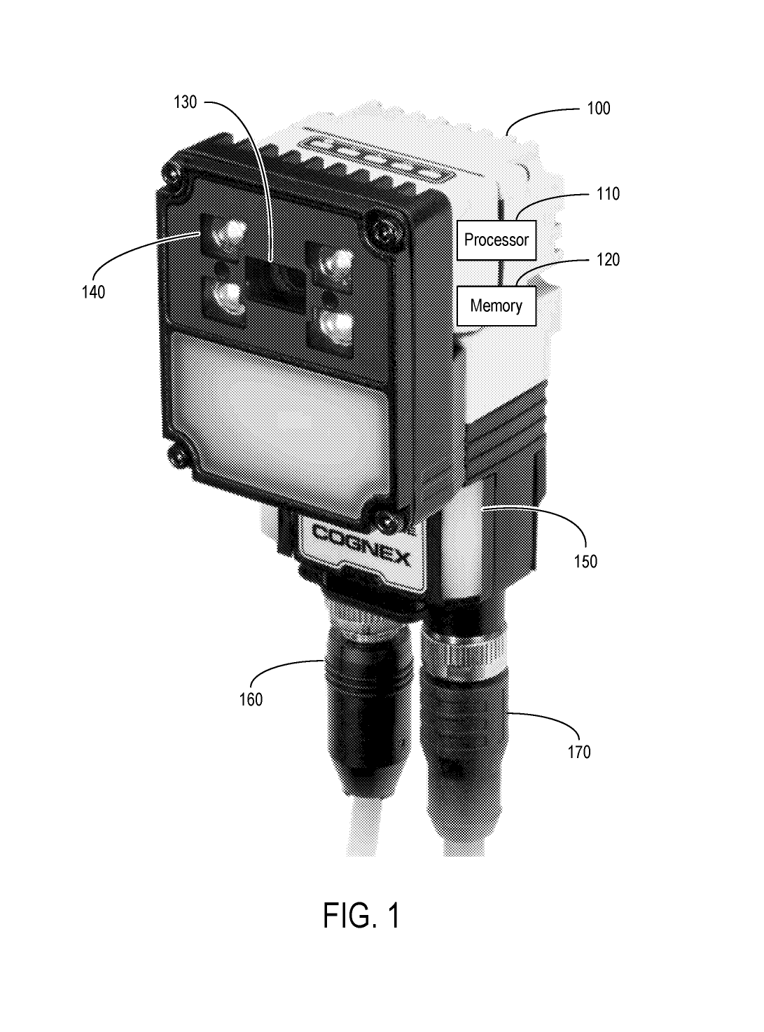

FIG. 1 illustrates an example of a machine vision system according to various aspects of the present disclosure. The machine vision system in the illustrated example has the form of a symbol reader 100 (e.g., a barcode reader), and includes a processor 110, a memory 120, an imaging system 130, an illumination system 140, an indicator 150, a communication interface 160, and a power supply interface 170. However, the symbol reader 100 is presented by way of example and not limitation. In some implementations, the machine vision system may have a different form factor, may include additional components (e.g., additional electrical or optical components) not illustrated in FIG. 1, or may omit certain components illustrated in FIG. 1.

As used herein, the term “processor” may include one or more processors and memories or one or more programmable hardware elements. As used herein, a “processor” may include one or more individual processing units or one or more individual processing cores. Where a processor is referred to as performing a method or operation, various procedures, sub-operations, steps, etc. may be performed by the same processing unit/core or by different processing units/cores, in series or in parallel, in any combination. As used herein, the term “processor” is intended to include any of types of processors, central processing units (CPUs), graphics processing units (GPUs), microcontrollers, digital signal processors, or other devices capable of executing software instructions. For the avoidance of doubt, cloud processing is contemplated in the definition of a processor.

As used herein, the term “memory” includes a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; or an installation medium, such as software media, e.g., a CD-ROM, or floppy disks, on which programs may be stored or data communications may be buffered. The term “memory” may also include other types of memory or combinations thereof. For the avoidance of doubt, cloud storage is contemplated in the definition of memory.

The imaging system 130 may include one or more image sensors configured to capture images of a symbol (e.g., a symbol affixed to an object traveling on a transport device). The image sensors may include complementary metal-oxide-semiconductor (CMOS) sensors, charge coupled devices (CCDs), or any other image sensor architecture. The image sensors may additionally or alternatively include depth sensors, such as one or more time-of-flight (ToF) sensors, light detection and ranging (LiDAR) sensors, and the like. The imaging system 130 may further include one or more optical components, such as a liquid lens configured to provide a range of focus distances. The imaging system 130 may be configured to capture two-dimensional (2D) images, three-dimensional images (3D) images, or combinations of 2D and 3D images.

The illumination system 140 may include one or more light emitting diodes (LEDs) to provide illumination of the object being imaged, including direct or diffuse illumination. In the illustrated example, the illumination system 140 includes an array of four LEDs and one diffuse illumination source. The indicator 150 may include any device configured to provide feedback to an operator of the machine vision system. In the illustrated example, the indicator 150 includes multiple status lights to provide visual feedback to the user. In other examples, the indicator 150 may include haptic feedback devices, auditory feedback devices, interactive display devices, and the like (e.g., lighting, audio, display, or haptic devices of various known configurations).

The communication interface 160 provides an interface to permit the machine vision system to receive communications from external devices or transmit communications to external devices. In examples, an external device may be an external computing device (e.g., a server, a laptop computer, a desktop computer, a notebook computer, a tablet computer, a smartphone, and the like). Additionally or alternatively, an external device may be another symbol reader (e.g., another barcode reader positioned at a different physical location or with a different orientation), which may be the same as or different from the symbol reader 100 shown in FIG. 1. In the illustrated example, the communication interface 160 is a wired communication interface; however, the communication interface 160 may additionally or alternatively include wireless communication interfaces, such as Wi-Fi, Bluetooth, near field communication (NFC), radio frequency (RF), or other interfaces. Additionally, while the illustrated example shows a single communication interface 160, the symbol reader 100 may include more communication interfaces or may provide for connection to multiple external devices. In one example, the communication interface 160 may include a first connection for receiving and transmitting communications to and from an external computing device, and a second connection for receiving and transmitting communications to and from another symbol reader. In yet another example, the communication interface 160 may include multiple connections for receiving and transmitting communications to and from multiple other symbol readers (e.g., in a daisy chain configuration).

The power interface 170 provides an interface to provide power to components within the machine vision system. In one example, the power interface 170 is configured for connection to a mains power source, thereby to provide direct and continuous power to the internal components of the symbol reader 100 (e.g., the processor 110, the memory 120, etc.). In examples in which the machine vision system includes an internal battery (e.g., a rechargeable battery), the power interface 170 may be additionally or alternatively configured to provide power to the battery (e.g., to charge the battery), thereby to provide a persistent power source that permits operation of the symbol reader 100 in the case of an interruption in the mains power source or with the mains power source disconnected. In the illustrated example, the power interface 170 is a wired power interface; however, the power interface 170 may additionally or alternatively include components (e.g., inductive elements, capacitive elements, etc.) to permit wireless power transfer.

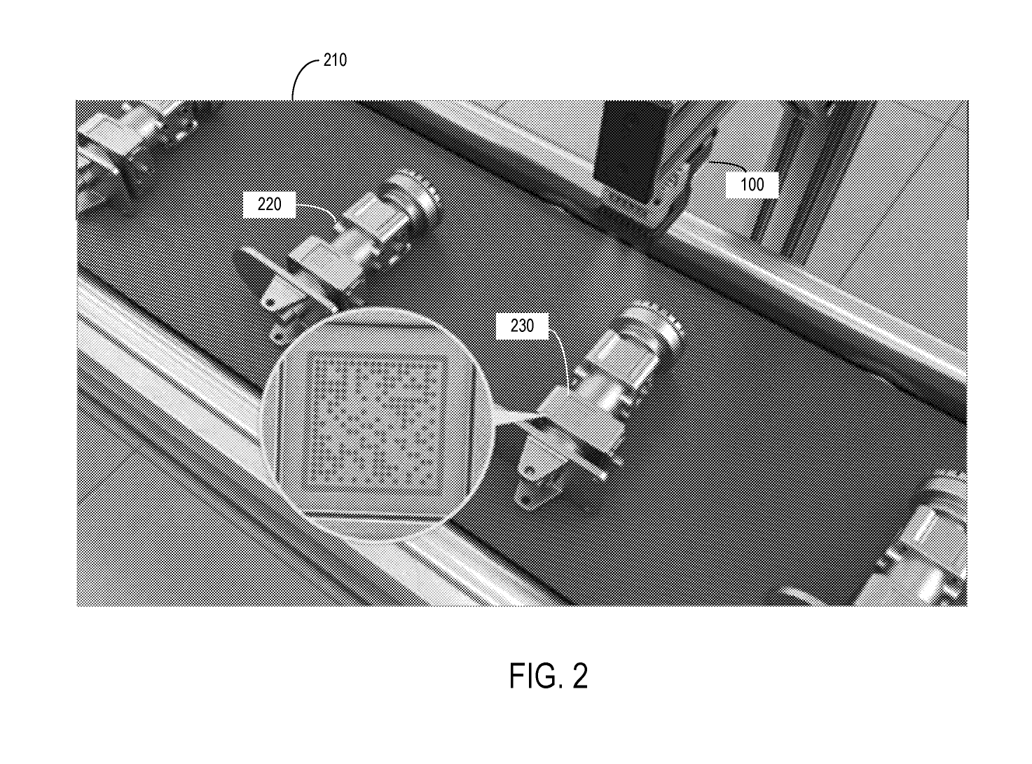

FIG. 2 illustrates an example use case for the symbol reader 100 of FIG. 1. In use, the symbol reader 100 is fixedly mounted above a transport device 210 (e.g., a conveyor). The transport device 210 provides a moving surface or web. A plurality of objects 220 pass by a field of view (FOV) of the symbol reader 100 while on the transport device 210. The objects 220 each include a code 230 on a surface thereof. As each object 220 passes through the FOV of the symbol reader 100, the symbol reader 100 identifies the code 230 and decodes it. To ensure proper operation of the symbol reader 100, however, the symbol reader 100 should be positioned within a particular distance range above the surface of the transport device 210, such that the codes 230 are at a favorable size (e.g., within a target PPM range) in the images captured by the symbol reader 100.

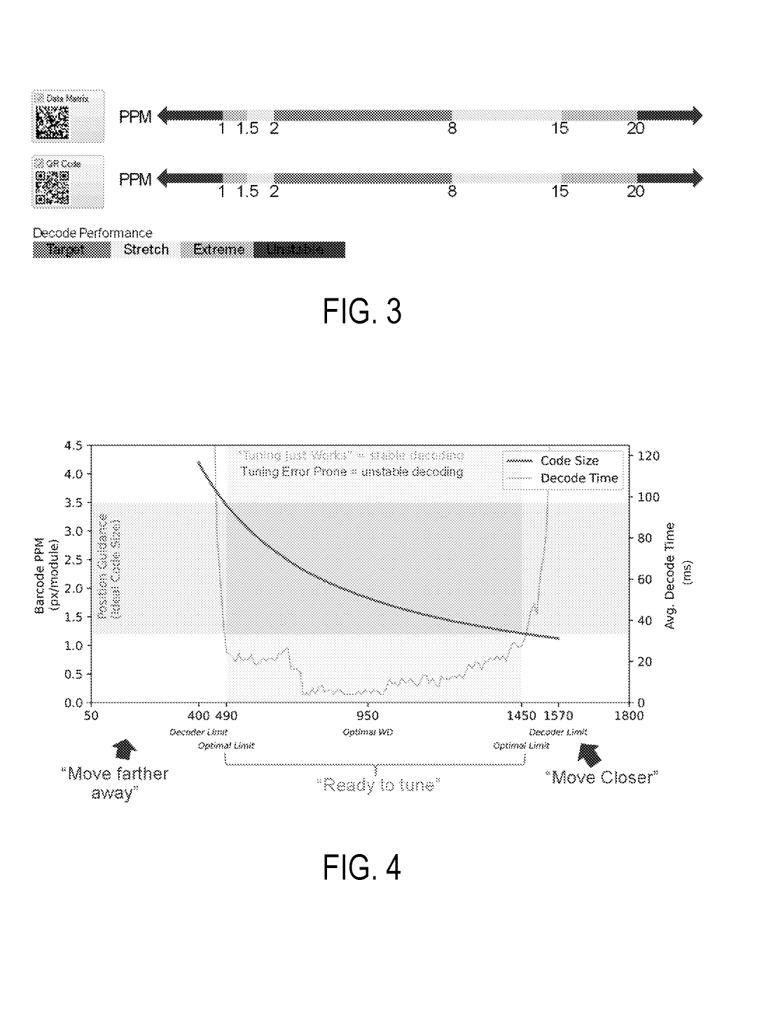

FIG. 3 illustrates an example of the effects of the distance on the images captured by the symbol reader 100. In particular, FIG. 3 illustrates two example symbologies that may be imaged by the symbol reader 100; however, the present disclosure is not limited to any particular symbology. As used herein, “symbology” refers to a code type and is generally indicative of one or more constraints for the code 230. For example, different symbologies may have different size constraints, dot resolution constraints, etc. Herein, the symbology may include one-dimensional symbologies (e.g., barcodes), two-dimensional symbologies (e.g., QR Codes, Data Matrix Codes, etc.), text symbologies, image-based symbologies, etc.

In FIG. 3, both QR Code and Data Matrix Code symbologies are shown. For both symbologies, the target level of performance in the illustrative example is reached for PPM values between 2 and 8. For PPM values between 1.5 and 2 or 8 and 15, the performance may be degraded. For PPM values between 1 and 1.5 or 15 and 20, the performance may be degraded even further. Finally, for PPM values less than 1 or greater than 20, the performance may be unstable. It should be noted that the symbologies in FIG. 3 exhibit similar behaviors for performance vs. barcode PPM; however, other symbologies may have different constraints. In general, the machine vision systems and methods of the present disclosure may be used to image and decode any number of symbologies. In such examples, the target performance for each symbology may be determined, and a target PPM may then be selected to provide the highest degree of performance among all symbologies.

FIG. 4 illustrates the relationship between imaging and image processing parameters and the distance between the symbol reader 100 and the surface of the transport device 210. FIG. 4 simultaneously displays the barcode size in PPM as a function of the distance, and the average decode time as a function of the distance. In the illustrated example, the target decode performance is reached for a barcode PPM between approximately 1.2 and 3.5. This performance is reached at working distances of between 490 and 1450 mm. At these distances, the average decode time is sufficiently small (e.g., less than a target time, which in the illustrated example is 35 ms) to permit successful operation of the symbol reader 100. In other words, these distances provide for stable decoding after the symbol reader 100 has been tuned. At distances outside of this range, the average decode time increases substantially such that the tuning may be error prone or the decoding is unstable. Moreover, in implementations where the image is part of a stream of image frames (i.e., a video) and the transport device 210 travels at a high speed, an increase in the average decode time may render the symbol reader 100 incapable of decoding symbols on the object sufficiently quickly to permit real-time operation.

As noted above, comparative techniques for installing and tuning machine vision systems require the user to visually gauge the size of the symbol in a subjective manner, and are prone to the above-noted operational shortcomings. Thus, the systems and methods set forth herein provide for automated guidance to the user. If the distance is above the upper limit, the systems and methods herein instruct the user to move the symbol reader 100 closer during the installation step. If the distance is below the upper limit, the systems and methods herein instruct the user to move the symbol reader 100 farther away during the installation step. If the distance is within the preferred range, the systems and methods herein instruct the user that the system is ready for tuning.

Thus, once the code size in image space (e.g., in PPM) and the symbology are determined, it is immediately known whether the code size is too small or large for the decoding algorithms and subsequent tuning operation. With this information, prompts may be provided to the user (e.g., per image frame), indicating that the system is ready to proceed to tuning or that the working distance must first be adjusted.

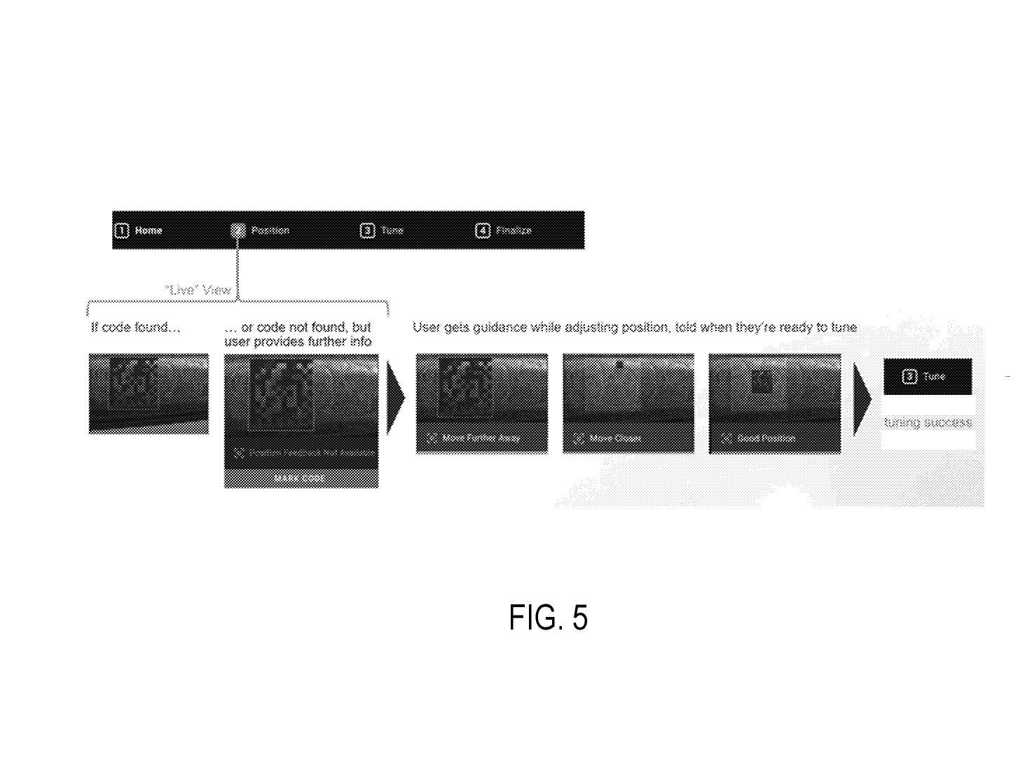

FIG. 5 illustrates one example of how the system may operate with a graphical UI (GUI). The GUI in the illustrated example includes a display portion that presents a live view of the FOV of the symbol reader 100. If a code is found within the FOV (or if the user provides further information, for example by indicating a portion of the live view that includes a code), the image is analyzed to determine barcode size and subsequent PPM to provide position guidance. For example, the GUI may instruct the user to move further away or to move closer to the object being imaged. Once the symbol reader 100 is in a “good” position (e.g., at an acceptable working distance), the user may be instructed that the system is ready for tuning. In some examples, at this point the user may fix the symbol reader 100 at its position and manually initiate the tuning process. In other examples, however, the system may automatically proceed with tuning (e.g., by waiting until a predetermined time has passed without any movement of the symbol reader 100, thereby to infer that the symbol reader 100 has been fixed, and then proceeding with the tuning process without further user input).

There are several potential methods that may be used to determine the barcode size and subsequent PPM and position guidance. In one example, the code size may be obtained directly from a decode result by running the decoder (or a portion of the algorithms dedicated to code finding) on each image frame. This may require no extra input from the user, and can provide near-instantaneous guidance on installation while in the live view mode. In another example, if parameters of the device (e.g., the imager type, lens, working distance) are known, the estimated PPM may be back-calculated (e.g., via focus plane estimation, TOF/depth sensor input, user input, artificial intelligence (AI) based estimation, etc.) and the corresponding guidance may be provided. This implementation may receive as input the printed size of the barcode (e.g., in mm/module or “mil size”) or an approximate outline of the barcode in the image as drawn by the user or found by a rules-based or AI pattern tool.

Thus, the systems and methods described herein provide a higher success rate from the tuning operation, allowing for out-of-box setup in less time even for users that do not have a high degree of experience with machine vision. Guiding the symbol reader 100 to preferred PPM ranges also improves the read rate and decode time performance, for example because users will be less susceptible to setting up their devices on the edge of (or past) performance constraints. Moreover, proper setup may be ensured without any need for exposing underlying decoding settings, further reducing the need for specialized skills or training. By way of example, a comparative tuning method may require ten or more minutes for a single tuning operation when faced with challenging parts. If the user initially attempts to set up the reader outside of the preferred distance, this tuning method may need to be repeated any number of times.

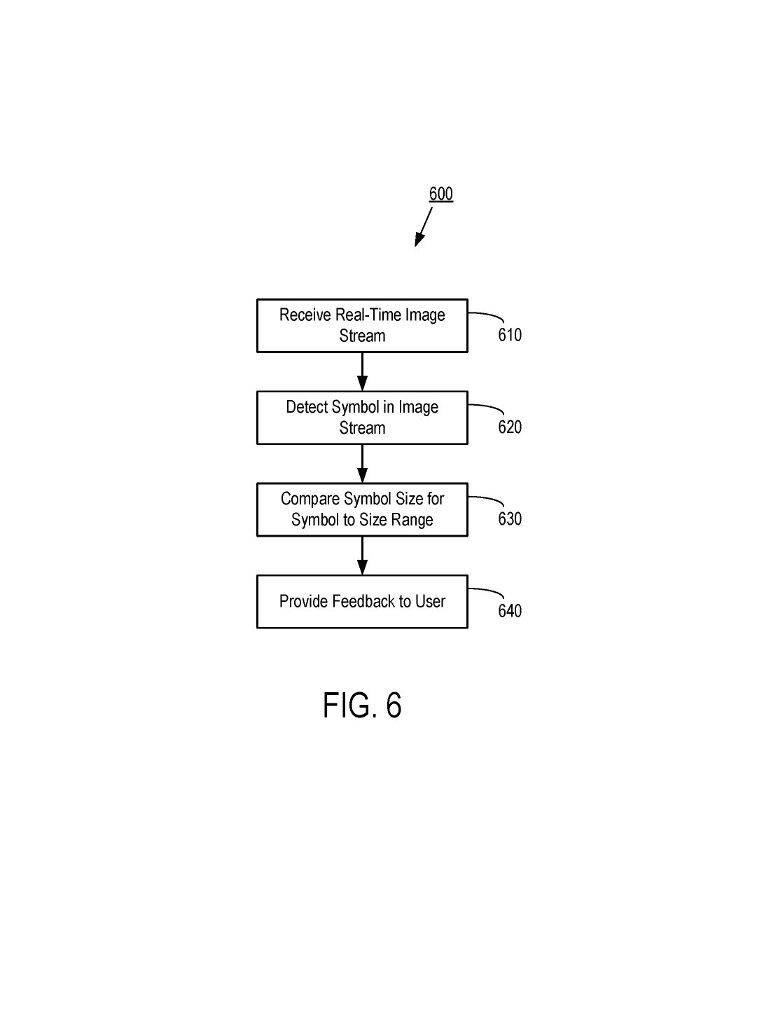

FIG. 6 illustrates an example method 600 in a vision system. For purposes of illustration, the method 600 will be described as being performed by the symbol reader 100 of FIG. 1. However, it should be understood that the method 600 may be performed by any vision system for imaging an object (e.g., an object on a transport device) so long as the vision system includes an imaging device, a memory, and at least one processor operatively connected to the memory. The method 600 may be embodied in the form of computer readable instructions (e.g., stored in a non-transitory computer-readable medium) that are executable by at least one processor (e.g., the processor 110) to cause the vision system to perform the operations of the method 600.

The method 600 includes operation 610 of receiving an image acquired by the imaging device in real-time. The image may be received from the imaging device 130, and may be a part of a real-time image stream comprising a plurality of image frames in a time sequence. The method 600 further includes an operation 620 of detecting a symbol in the image. Candidate symbols can be identified using known image analysis approaches or by providing part or all of a captured image frame to a machine learning (ML) model (e.g., an ML model stored in the memory 120 or an ML model stored in an external device). Operation 620 may include determining a symbol size for a symbol (e.g., the code 230 shown in FIG. 2) in the FOV of the imaging device 130. The symbol size may be determined by providing the image to a ML model and receiving the symbol size from the ML model, or by using other known approaches for determining a symbol size (e.g., using standard image analysis to identify edges or other features of a symbol). Operation 620 may additionally or alternatively include determining a symbol type for the symbol. The symbol type may be determined by providing the image to an ML model, which may be different than (or the same as) the ML model used to determine the symbol size, and by receiving the symbol size (e.g., a PPM value) from the ML model. In some implementations, the ML model may further return a symbol location (e.g., in addition to the symbol size or type). As an example, the ML model used for determining the symbol type may implement one of a number of object detection approaches, such as Faster R-CNN (convolutional neural network), SSD, RetinaNet, EfficientDet, CenterNet, Cascase R-CNN, or a you-only-look-once (YOLO) ML model that implements a CNN. Moreover, the ML model used for determining the symbol size may implement a MobileNet, SqueezeNet, ShuffleNet, EfficientNet, NASNet-A-Mobile, or another lightweight CNN architecture.

The method 600 further includes operation 630 of comparing the symbol size determined in operation 620 to a predetermined size range. In examples, the predetermined size range may depend on the symbol type determined in operation 620. The predetermined size range may additionally or alternatively depend on a target symbol decode time for the vision system (e.g., to ensure that the vision system may decode a symbol sufficiently quickly to permit operation of the associated transport device at high speeds. The target symbol decode time may be (or may be based on) a framerate of video capture by the vision system or a target operation speed of the transport device with which the vision system will be used.

The method 600 includes operation 640 of, based on the comparison, providing a feedback. The feedback may be or include an indication of a relationship between an actual distance between the imaging device 130 and the symbol being imaged and a target distance (e.g., an absolute distance or a range of distances) between the imaging device 130 and the symbol. For example, if the actual distance is less than a lower end of the target distance range, operation 640 may include generating an instruction to cause the GUI to display an indication to move the imaging device 130 away from the symbol. Additionally or alternatively, in such case the feedback may include causing an indicator (e.g., the indicator 150) to illuminate in a manner indicative of the need to move the imaging device 130 away from the symbol (e.g., by emitting amber light, by flashing a first code, etc.). If, on the other hand, the actual distance is greater than an upper end of the target distance range, operation 640 may include generating an instruction to cause the GUI to display an indication to move the imaging device 130 toward the symbol. Additionally or alternatively, in such case the feedback may include causing the indicator 150 to illuminate in a manner indicative of the need to move the imaging device 130 nearer to the symbol (e.g., by emitting red light, by flashing a second code, etc.). If it is determined that the actual distance is within the target distance range, operation 640 may include generating an instruction to cause the GUI to display an indication that the system is ready for tuning or causing the indicator 150 to illuminate in a manner indicative of acceptable placement of the imaging device 130 relative to the symbol (e.g., by emitting green light, by flashing a third code, etc.). Alternatively, the tuning operation may automatically begin if the actual distance is within the target distance range.

In examples, the method 600 may be configured to further adjust the imaging device without requiring input or operation by the user. For example, the imaging device may be mounted in an adjustable manner, with actuators and the like able to automatically reposition the imaging device. In such examples, operation 640 may include providing feedback in the form of instructions to the actuator or other components that automatically change the position or orientation of the imaging device, thereby to cause the actual distance to fall within the predetermined range. Whether the repositioning is performed automatically or by a user, after the completion of operation 640 the method 600 may return to 610 to determine anew whether the vision system is ready for tuning.

In some examples, the vision system may include a motion detector to detect a motion of the imaging device (e.g., by providing a motion detection signal to the processor 110). If it is determined that the motion has exceeded a threshold, the user may be instructed to reinitiate the tuning procedure (e.g., to trigger another adjustment of the focus and exposure). The motion detection signal may additionally or alternatively be generated by a depth sensor (e.g., a ToF sensor or a LiDAR sensor) based on a detected change in the distance between the imaging device 130 and the symbol. The processor 110 may further be configured to provide an updated feedback in response to a movement of the imaging device with respect to the symbol.

Accordingly, the systems and methods set forth above provide a setup process (e.g., installation and tuning procedures) that requires much less time than comparative techniques, and that provides lower decoding time (i.e., faster throughput) or higher read rate than comparative techniques.

The particular aspects disclosed above are illustrative only, as the technology may be modified and practiced in different but equivalent manners apparent to those skilled in the art having the benefit of the teachings herein. Furthermore, no limitations are intended to the details of construction or design herein shown, other than as described in the claims below. It is therefore evident that the particular aspects disclosed above may be altered or modified and all such variations are considered within the scope and spirit of the technology. Accordingly, the protection sought herein is as set forth in the claims below.

What is claimed is:

1. A vision system for imaging an object comprising:
an imaging device configured to acquire an image;
a memory in communication with the imaging device; and
at least one processor operatively connected to the memory and configured to:
receive, in real-time, the image acquired by the imaging device,
determine a symbol size for a symbol in a field-of-view of the imaging device,
determine a symbol type for the symbol,
compare the symbol size to a predetermined size range, the predetermined size range being based on the determined symbol type, and
provide a real-time feedback based on the comparing, wherein the real-time feedback indicates a relationship between an actual distance between the imaging device and the symbol and a target distance between the imaging device and the symbol.

2. The vision system of claim 1, wherein
the memory stores a machine learning model, and
the at least one processor is configured to determine the symbol type by providing the image to the machine learning model and by receiving the symbol type from the machine learning model.

3. The vision system of claim 1, wherein
the memory stores a machine learning model, and
the at least one processor is configured to determine the symbol size by providing the image to the machine learning model and by receiving a pixels-per-module value from the machine learning model.

4. The vision system of claim 1, wherein the at least one processor is configured to provide the feedback by:
in response to a determination that the actual distance is less than the target distance range, generating an instruction to cause a graphical user interface (GUI) to display an indication to move the imaging device away from the symbol, and
in response to a determination that the actual distance is greater than the target distance range, generating an instruction to cause the GUI to display an indication to move the imaging device toward the symbol.

5. The vision system of claim 1, further comprising an indicator, wherein the at least one processor is configured to provide the real-time feedback by controlling an illumination of the indicator based on the comparing, wherein controlling the illumination includes at least one of causing the indicator to illuminate or controlling an illumination color of the indicator.

6. The vision system of claim 1, wherein the at least one processor is configured to receive a real-time image stream including the image, the real-time image stream comprising a plurality of image frames in a time sequence, and to provide the real-time feedback based on the real-time image stream that indicates relationships between actual distances between the imaging device and the symbol and the target distance between the imaging device and the symbol.

7. The vision system of claim 1, wherein the at least one processor is configured to provide an updated feedback in response to a movement of the imaging device with respect to the symbol.

8. The vision system of claim 1, wherein the predetermined size range is further based on a target symbol decode time for the vision system.

9. The vision system of claim 1, wherein the imaging device is a two-dimensional area scan imaging device.

10. The vision system of claim 1, wherein the imaging device, the memory, and the at least one processor are positioned within a vision system housing.

11. A method of imaging an object, comprising:
receiving an image in real-time from an imaging device;
detecting a symbol in the image;
determining a symbol size and a symbol type for the symbol; and based on a comparison between the determined symbol size and a predetermined size range that is based on the determined symbol type, providing a real-time feedback based on the comparing, wherein the real-time feedback indicates a relationship between an actual distance between the imaging device and the symbol and a target distance between the imaging device and the symbol.

12. The method of claim 11, wherein determining the symbol type includes:
providing the image to a machine learning model, the machine learning model including a convolutional neural network; and
receiving the symbol type from the machine learning model.

13. The method of claim 11, wherein determining the symbol size includes:
providing the image to a machine learning model, the machine learning model including a convolutional neural network; and
receiving a pixels-per-module value from the machine learning model.

14. The method of claim 11, wherein providing the real-time feedback includes:
in response to a determination that the actual distance is less than the target distance range, generating an instruction to cause a graphical user interface (GUI) to display an indication to move the imaging device away from the symbol, and
in response to a determination that the actual distance is greater than the target distance range, generating an instruction to cause the GUI to display an indication to move the imaging device toward the symbol.

15. The method of claim 11, further comprising:
in response to a determination that the symbol size is within the predetermined size range, automatically initiating a tuning procedure of the imaging device.

16. The method of claim 11, further comprising:
detecting a motion of the imaging device, and
generating an instruction to reinitiate a tuning procedure in response to the motion.

17. The method of claim 11, wherein the image is a frame of a video captured by the imaging device.

18. The method of claim 17, wherein the predetermined size range is further based on at least one of a framerate of the video or a speed of a transport device on which the object is disposed.

19. The method of claim 11, wherein the real-time feedback is configured to cause a repositioning of the imaging device relative to the symbol.

20. The method of claim 19, wherein the repositioning is performed by an actuator operatively connected to the imaging device.
